(19) United States
(12) Patent Application Publication
(10) Pub. No.: US 2012/0154679 A1
(43) Pub. Date: Jun. 21, 2012

(54) USER-CONTROLLED SYNCHRONIZATION OF AUDIO AND VIDEO

(75) Inventor: Robert S. Pendarvis, Voorhees, NJ (US)

(73) Assignee: Comcast Cable Communications, LLC, Philadelphia, PA (US)

(21) Appl. No.: 12/974,537

(22) Filed: Dec. 21, 2010

(51) Int. Cl. H04N 9/475

(52) U.S. Cl. 348/512; 348/E09.034

(57) ABSTRACT

Devices, methods, and computer-readable media having program instructions for performing functions are described for synchronizing audio and video components of a media program. If audio and video components of an audiovisual program and routed through different processing devices, such as a home theater system, the viewer of the audiovisual program may perceive a synchronization mismatch between the audio and video components. As described herein, the viewer is provided with the ability to adjust a delay of one of the components relative to the other component, such that synchronization is achieved. In some variations, a user interface is provided to give the viewer feedback concerning the relative delay between one component and the other.

### BACKGROUND

When media programs having audio and video components are rendered on one or more display devices such as a television, a computer monitor, and home theater systems, a synchronization mismatch may occur between the audio and video components. This so-called “lip synchronization” mismatch, by which a viewer of the program perceives that a person's lips on the video display do not move in synchronization with the perceived audio, may be frustrating for the viewer. A mismatch between audio and visual components may occur in other contexts. Such issues may arise, for example, when the audio and video components of the program are routed through different processing components that may introduce different delays into each path.

For example, content such a television program may be received at a user's home and demodulated by a receiving terminal, such as a home computer or a set-top box (STB). The terminal may demodulate the signal and separate it into its audio and video components and output those components to the user's equipment, such as a television. The user may have arranged his or her equipment such that the audio component of the program is routed through home audio equipment (equalizers, amplifiers, speakers, etc.) that are separate from and not synchronized to the video component, which may be routed from the terminal directly to a television. Delays introduced in the audio path of the signal and arriving at the speakers may lead to the viewer's perception that the audio component of the program is out of synchronization with the video component of the program. Conversely, the video portion of the program may be routed through video processing equipment relative to the audio component, causing delays in the video component relative to the audio component.

### SUMMARY

Described herein are methods, devices, and computer-readable media having stored instructions that may permit a user to adjust synchronization between audio and video components of a media program, such as a television program transmitted by a content provider or content accessible on a network, such as the Internet. In some variations, a remote control device cooperates with a terminal, such as a set-top box, to generate a user interface that allows the user to see and hear both the audio and video signals while interactively adjusting a delay between the two signals. The user interface may provide feedback to the user illustrating the effect of the user's adjustments.

Embodiments include one or more methods, devices, and computer-readable media having stored program instructions that, when executed, perform various steps or functions. Such steps may include receiving and demodulating a program signal; selecting and demultiplexing an audiovisual program from the program signal; separating the audiovisual program into a video component and an audio component; generating a user interface allowing a user to select an audio and video path to be synchronized; variably delaying either the audio or video signal path under user control; and outputting the variably delayed signals.

In some variations, the user interface may include a simulated video program showing a moving object that hits another object, and prompts to guide the user to select the paths to be synchronized and to variably adjust the synchronization. The user may adjust the delay of the audio or video path relative to one another while watching the simulated video program, thus receiving feedback concerning the adjustment as it is made. In other variations, the user interface may include a live program, such as a television broadcast.

Various features may be implemented in a terminal, such as a set-top box having circuitry programmed to carry out various functions and steps as described herein. Some or all of the features may be implemented in software, such as in a general-purpose computer, or they may be implemented in a combination of hardware and software.

The preceding presents a simplified summary in order to provide a basic understanding of some aspects of the disclosure. The summary is not an extensive overview of the disclosure. It is neither intended to identify key or critical elements of the disclosure nor to delineate the scope of the disclosure. The summary merely presents some concepts of the disclosure in a simplified form as a prelude to the description below.

### BRIEF DESCRIPTION OF THE DRAWINGS

The present disclosure is illustrated by way of example and not limited in the accompanying figures in which like reference numerals indicate similar elements and in which:

FIG. 1 shows a terminal arranged to carry out various steps and functions disclosed herein.

FIG. 2 illustrates an example hardware platform on which various elements and functions described herein can be implemented.

FIGS. 3A through 3D shows various user interface screens that may be used to synchronize paths in accordance with one or more aspects disclosed herein.

FIGS. 4A through 4C show various user interface screens that may be used to interactively synchronize audio and video paths in accordance with one or more aspects disclosed herein.

FIG. 5A shows audio and video components of a program that are properly synchronized.

FIG. 5B shows audio and video components of a program that are out of synchronization.

FIG. 5C shows audio and video components of a program that have been re-synchronized by delaying a component of the program.

FIG. 6 shows various steps of a method that may be carried out using certain principles described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be used, and structural and functional modifications may be made, without departing from the scope of the present disclosure.

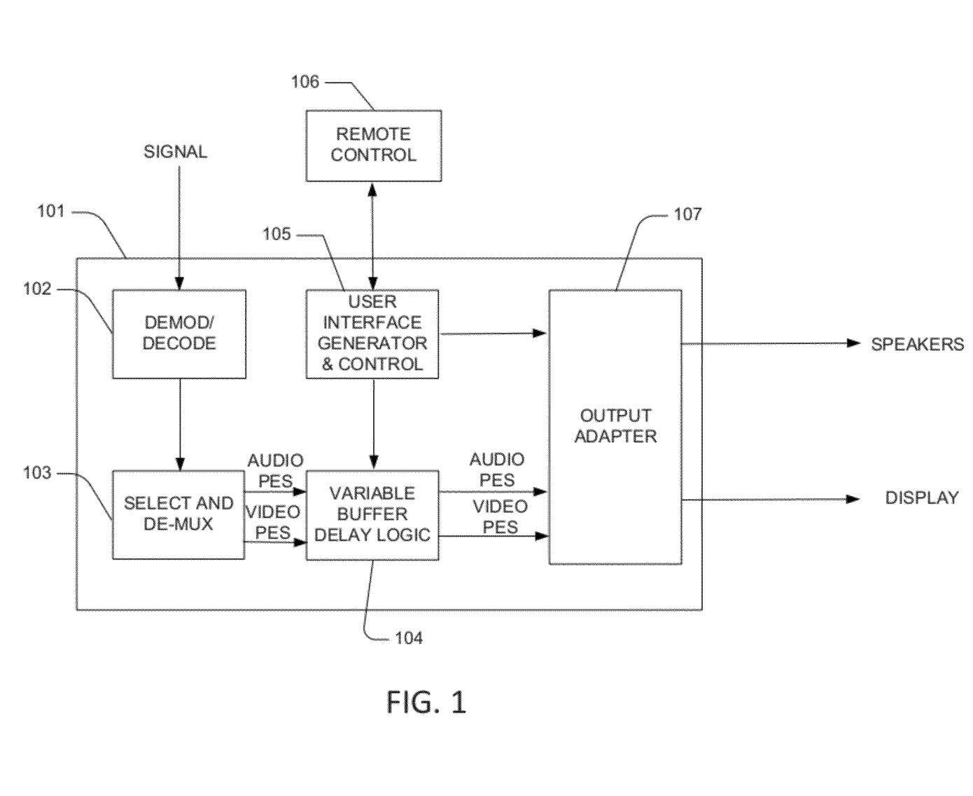

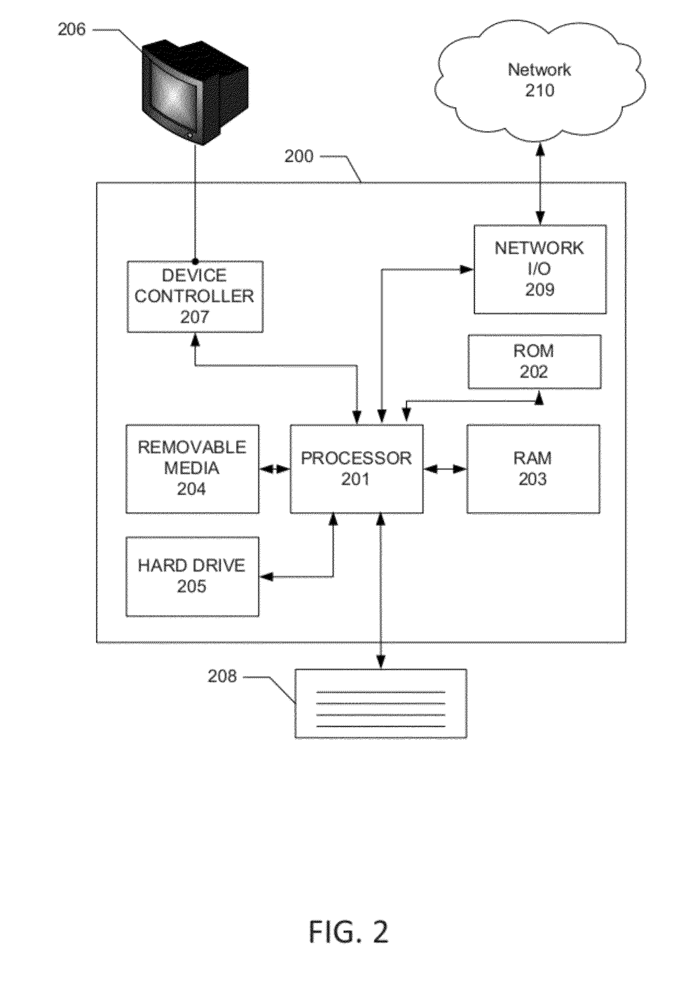

FIG. 1 shows an example of a terminal 101 having various components, such as one or more electronic circuits programmed to perform functions as described herein. As described in more detail below in connection with FIG. 2, the terminal may include one or more processors and memories having instructions that, when executed, carry out various functions and steps. Terminal 101 may comprise a device such as a set-top box (STB) that receives a signal from a content provider, e.g., a cable, satellite, or wireless network provider, and processes (e.g., demodulates) the signal for display on a television or other display unit. Terminal 101 may also comprise a gateway or a computer, such as a home PC or other device, programmed to carry out functions typically associated with an STB. Other types of terminals are possible and the principles described herein are not intended to be limited to any particular type of hardware device. Digital video recording (DVR) functions may also be implemented in the terminal.

As shown in FIG. 1, a program signal may be received, for example, as a radio frequency quadrature amplitude modulated (QAM) signal, as is often received over a hybrid fiber cable (HFC) network. Other types of signals may be received from various types of networks (optical, wireless, satellite, etc.) and demodulated and decoded and/or otherwise processed for display on a device. Examples include, but are not limited to, fiber optic or HFC networks; wireless networks such as cellular telephone or local wireless networks (e.g., WiMAX); satellite networks; Ethernet, etc. Multiple programs may be transmitted such as by broadcast or narrowcast methods (e.g., multicast or unicast) using, for example, radio frequency or packet-based technologies and multiplexed or modulated into a single combined signal. As illustrated in FIG. 1, the program signal is received in terminal 101, which may be located, for example, at a user's home or office.

In the example terminal shown in FIG. 1, a demodulator/decoder 102 receives the program signal and demodulates and/or decodes the signal. For example, demodulator/decoder 102 may output an MPEG-2 transport stream. An MPEG program selector/demultiplexer 103 may receive the transport stream and, typically under control of user input via a remote control 106, select a program of interest to the viewer and demultiplex that program into separate audio and video packetized elementary streams (PES). This exemplary embodiment relates to the MPEG-2 standard, and this description is not limited to such standard or to any other standard. Other specifications and technologies for decoding and demultiplexing media programs having audio and visual components may be used without departing from the principles described herein.

The separate audio and video packetized streams may be input to a variable buffer delay logic circuit 104, which separately buffers the audio and video packet streams with the ability to delay one stream relative to the other. Techniques for buffering and delaying one stream relative to another are well-known and no further discussion is necessary to understand the principles described herein. Circuit 104 may delay either the audio stream or the video stream relative to the other under control of the user.

A user interface generator and control circuit 105 may provide an input to variable buffer delay logic circuit 104 in order to allow the user to control (via remote control 106, for example) the delay of one stream relative to another. Further details of this feature are described below. Other user control mechanisms, such as a touch-screen display, keyboard, dedicated buttons, or the like may be used instead of a remote control.

The variably delayed audio and video packetized elementary streams may be output to an output adapter circuit 107, which may convert the audio and video streams into one or more desirable output formats (analog or digital) before exiting the terminal 101. For example, the audio stream may be output as baseband audio; as S/P DIF audio; or as HDMI audio, among others. Each of these formats may have its own standard type of connector (e.g., wired or wireless), often on the back of the terminal, to allow connection to a display device such as a television. Alternatively, the audio stream may be output in packetized form to be transmitted over an Ethernet, for example. The output adapter circuit 107 may also convert the video PES into one or more desired video output formats, such as component video; composite video; or HDMI video, for example. As with the audio outputs, the video stream may be output in packetized form to be transmitted over an Ethernet, for example.

The user interface generator and control circuit 105 may also generate a video output to output adapter 107 in order to display a user interface allowing a user to control the variable delay function. Further details of this user interface are provided below.

As shown in the example of FIG. 1, a composite signal including various program signals may be received at terminal 101. One of the audiovisual programs included therein may be demodulated, decoded, and demultiplexed (or otherwise separated) into separate audio and video components. The separate audio and video components may be passed through a variable buffer delay circuit or function, and one of the components is delayed under user control relative to the other. The adjusted (e.g., delayed) streams may be converted to a suitable output format and exit terminal 101 through one or more connectors. Terminal 101 may be constructed as a separate device or, in some variations, the functions shown in FIG. 1 may be implemented by upgrading software in a memory of a pre-existing device.

If no delay is introduced between the audio and video components in variable buffer delay logic circuit 104, and assuming the incoming audio and video components of the input signal are properly synchronized, then the output signals should exit the terminal 101 also in synchronization. However, as explained previously, if the audio or video path after exiting the device is routed through other components before being rendered on a display device or speakers, delays may be introduced into one path relative to the other, causing a perceived mis-synchronization between the two. Through the use of variable buffer delay logic circuit 104, a user may control the delay of one component relative to the other in order to regain perceived synchronization.

FIG. 2 illustrates general hardware elements that may be used to implement the functions and circuits shown in FIG. 1. The computing device or terminal 200 may include one or more processors 201, which may execute instructions of a computer program to perform any of the features described herein. The instructions may be stored in any type of computer-readable medium or memory, to configure the operation of the processor 201. For example, instructions may be stored in any type of a memory (e.g., solid state flash, disk, etc.) such as read-only memory (ROM) 202, random access memory (RAM) 203, removable media 204, such as a Universal Serial Bus (USB) drive, compact disk (CD) or digital versatile disk (DVD), floppy disk drive, or any other desired electronic storage medium. The computer-readable medium or memory does not include so-called “transitory” signals.

Instead of a general-purpose processor, any of various special-purpose processors such as field-programmable gate arrays (FPGAs) or application-specific integrated circuit (ASICs) may be used to implement the functions described herein. Accordingly, the term “processor” should be understood to refer to all of these and other possible implementations.

Instructions may also be stored in an attached (or internal) hard drive 205 or any other type of memory. The computing device 200 may include one or more output devices, such as a display 206 (or an external television), and may include one or more output device controllers 207, such as a video processor. There may also be one or more user input devices 208, such as a remote control, keyboard, mouse, touch screen, microphone, etc. The computing device 200 may also include one or more network interfaces, such as input/output circuits 209 (such as a network card) to communicate with an external network 210. The network interface may be a wired interface, wireless interface, or a combination of the two. In some embodiments, the interface 209 may include a modem (e.g., a cable modem), and network 210 may include an in-home network, a provider's wireless, coaxial, fiber, or hybrid fiber/coaxial distribution system (e.g., a DOCSIS network), or any other desired network.

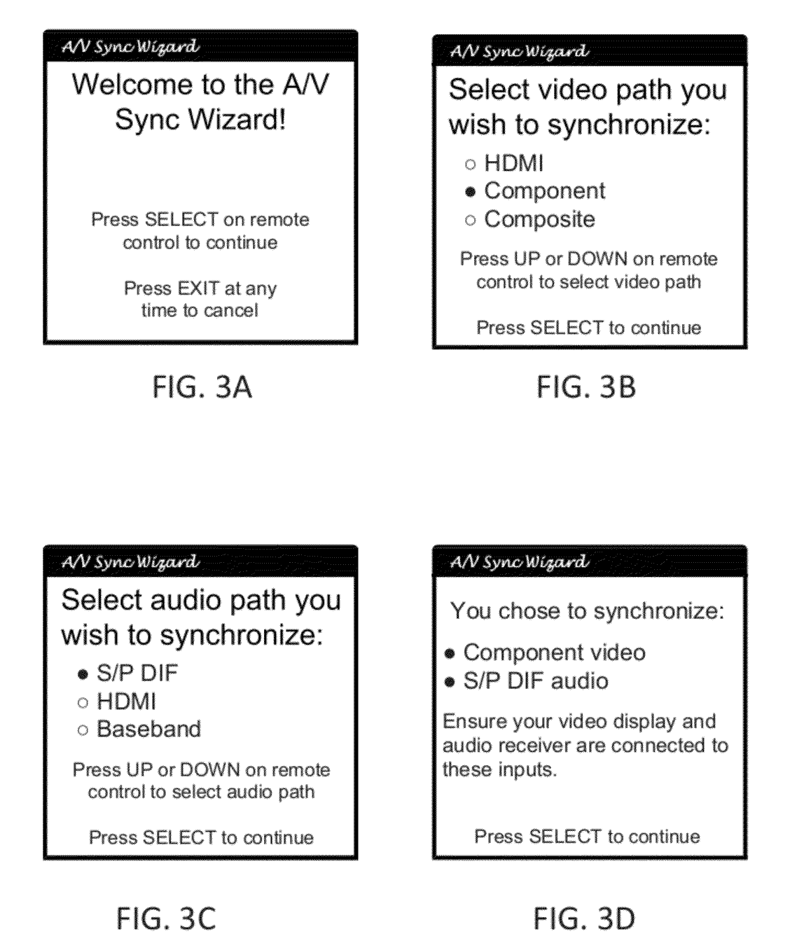

FIGS. 3A through 3D illustrate exemplary user interfaces that may be used to facilitate a user's initiation of the audio/video synchronization feature and to select signal paths for synchronization. The principles set forth in these figures are not, however, limited to this particular embodiment. The user interfaces may be generated, for example, by user interface generator and control circuit 105 (FIG. 1). The screen may be generated in response to a user selecting an audio/video synchronization function from a menu, from a remote control device (e.g., a dedicated button), or via some other invocation mechanism. The FIG. 3A screen instructs the user to press a key on the remote control to continue with the audio/video synchronization process.

FIG. 3B invites the user to select a video path that is to be synchronized. As shown in FIG. 1, for example, video outputs may be provided in various formats such as component video, composite video, or HDMI video. This feature is not necessarily included in all embodiments, as the audio and video packetized elementary streams may be variably synchronized at the packet (stream) level and then the synchronized streams separately provided to output adapter 107 and then simultaneously provided in all the available formats.

Since there may be multiple video output paths (e.g., HDMI, component, composite) and multiple audio output paths (e.g., HDMI, S/PDIF, baseband) on a terminal, the delay offset used to synchronize each combination of audio and video output paths could be different, because the user may have each of those outputs connected to different rendering devices. Consequently, in some embodiments, each path that a user intends to use may be synchronized independently and the terminal may store the delay offset for each path in non-volatile memory. Typically only one audio and one video rendering device would be active at a time. The user may configure the system once, when he or she first sets up the system, and then leave it without further changes.

The terminal may retrieve different pre-stored offset values based on which path is active. For HDMI, this may occur automatically for HDMI because there is link detection embedded in that protocol, so the terminal will know when HDMI is connected. For component, composite and baseband, there is no detection mechanism. In those cases, the user may inform the set-top box which interface is actively being used. A user interface screen (not shown) or other selection mechanism may be used to enable the user to select which interfaces are currently being used, and the terminal may then retrieve the corresponding audio/video delay offset that was previously stored in non-volatile memory for use in synchronizing the currently-active path.

FIG. 3C invites the user to select an audio path that is to be synchronized. As shown in FIG. 3C, the user may select one of the audio paths to be synchronized.

FIG. 3D shows a confirmation screen confirming that the user has elected to synchronize the component video path with the S/P DIF audio path.

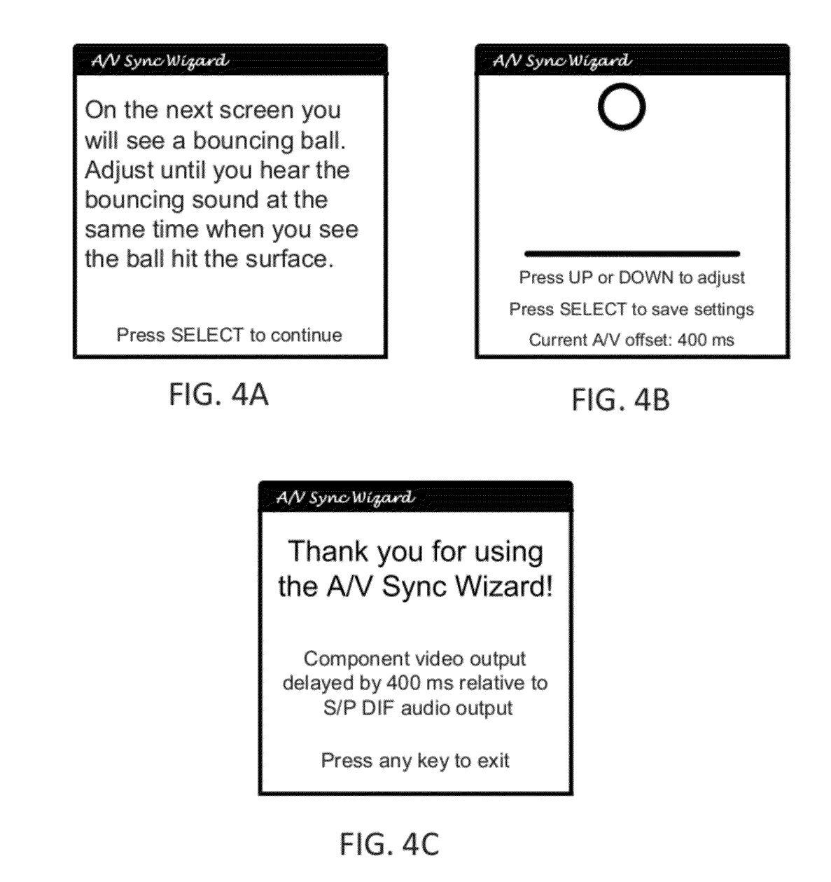

Turning to FIG. 4A, the user is presented with an informative screen explaining how to adjust synchronization of audio and video components.

FIG. 4B shows a user interface screen providing feedback to a user regarding the perceived synchronization of the audio and visual components of the program. In one variation, the user is presented with a simulated audiovisual program having a moving object and accompanying sound that that is generated when the object strikes another object. For example, as shown in FIG. 4B, a ball is repeatedly shown falling to a surface (video component) while the audio component is output. If the audio and video components are synchronized, the moving object will appear to hit the surface at the same instant that the audio component indicates a striking sound. If the components are not synchronized as perceived by the viewer, the image of the ball will strike the surface at a time different from (before or after) the striking sound is heard by the user.

The simulated audiovisual program may be stored in a memory of terminal 101 (e.g., memory 205 of FIG. 2) and introduced into variable buffer delay logic circuit 104 instead of a currently selected audiovisual program. Instead of (or in addition) to the simulated audiovisual program having a video object that appears to hit a surface at the same time an audio strike sound is generated, a live audiovisual program may be used as the basis for adjusting synchronization of the audio and video components. Programs having sounds that are closely correlated with video movements (e.g., a basketball game with balls being repeatedly dribbled on the court) may provide a more convenient display for providing feedback to the user.

If the user perceives a mismatch between the audio and video components, such as might occur if the audio component is routed through additional home theater equipment that introduces delays into the audio path, the user is invited to press one or more keys on the remote control to adjust the relative delay between the audio and video paths. For example, pressing an UP button on the remote control would increase the delay in the video path relative to the audio path. (Alternatively, the delay of the audio path relative to the video path may be adjusted. Although one or the other may be adjusted, if both are delayed by the same amount then no “re-synchronization” would actually occur).

As the user repeatedly presses the UP or DOWN button on the remote control, keyboard, or other input device, variable buffer delay logic 104 (FIG. 1) introduces a progressively larger or smaller delay between the selected audio and video components of the program. When the user is happy with the synchronization, the user is invited to press another button (e.g., SELECT) to save the delay settings in the apparatus. From that point forward, the audio and video delay paths will be delayed by the stored parameter set by the user.

The current audio/video offset may be displayed on the screen for reference. As shown in FIG. 4B, for example, the current audio/video offset is 400 milliseconds.

FIG. 4C shows a termination screen confirming completion of the audio/video synchronization process. In some embodiments, the relative amount of the delay that was saved may be indicated on the confirmation screen. As explained previously, in some embodiments different delays may be stored in the memory for different audio/video paths. For example, the device may store a default of zero delay (no offset) for HDMI audio and video outputs, but store a non-zero value for baseband audio and component video outputs.

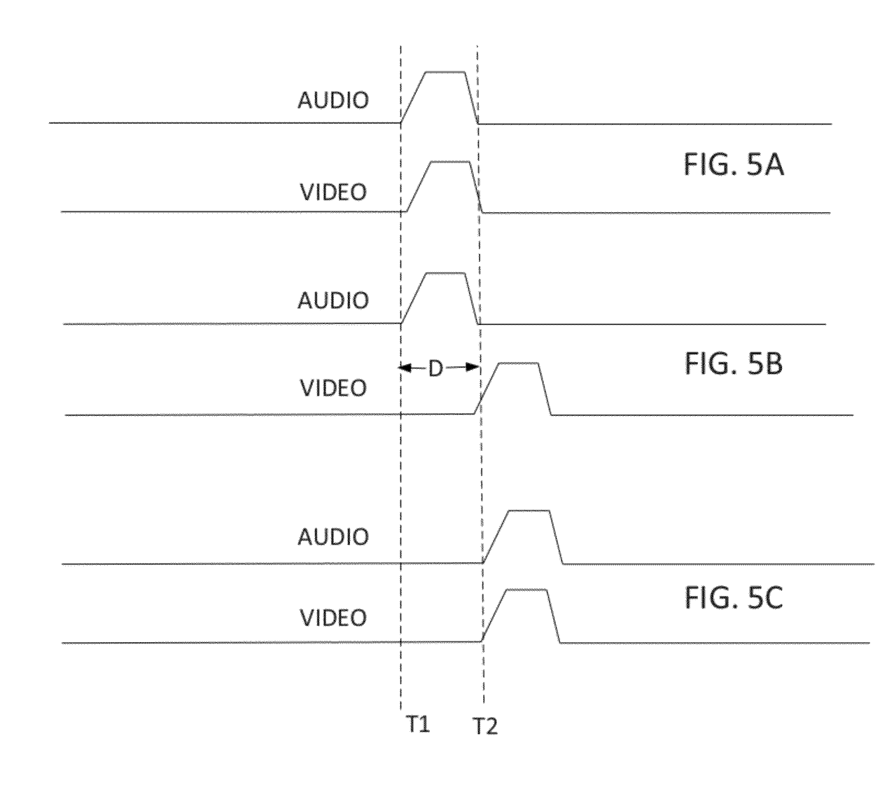

FIGS. 5A through 5C illustrate, e.g., an example of variable offset delay principles. In FIG. 5A, separate audio and video components (e.g., after demultiplexing) are in synchronization, assuming that the program was transmitted with synchronized audio and video components. (It is also possible that the audio and video components for certain programs may not be transmitted in synchronization from the originating source, and therefore may arrive at the terminal out of synchronicity. The principles and structures disclosed herein may be used to re-synchronize such components.)

In FIG. 5B, after the audio component has been routed out of the device and through other home audio equipment, the audio component (as perceived by the listener in speakers or headphones) lags the video component by a delay amount D. This delay amount may be tens or hundreds of milliseconds in magnitude, and may give the appearance of a “lip synchronization” mismatch in the program.

In FIG. 5C, after the user has adjusted the video path to also be delayed by the amount D, the user perceives both the audio and video components to again be synchronized. In reality, the audio path has been delayed by an amount D caused by external equipment through which the audio component was routed, while the video path has been delayed by an amount D in variable buffer delay logic circuit 104 to match the audio delay.

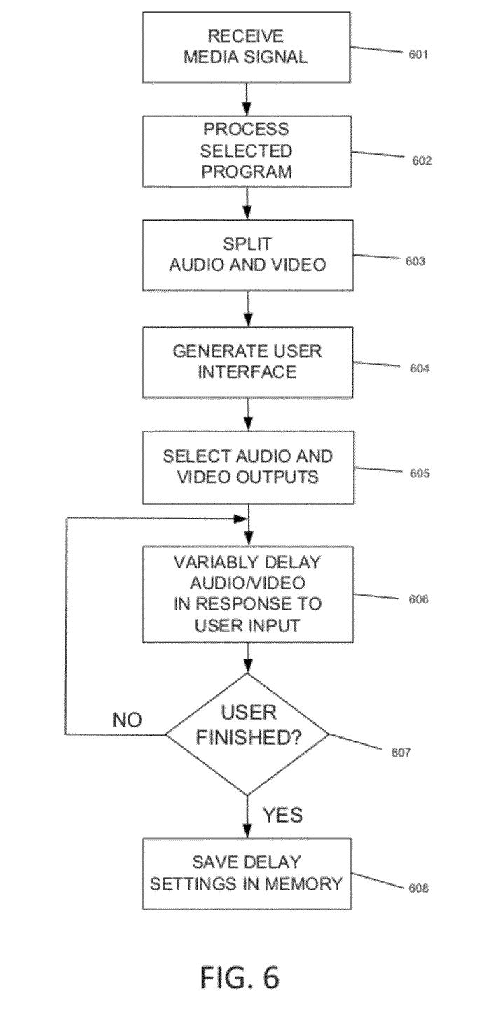

FIG. 6 shows various steps of a method that may be carried out. Any or all of the steps shown in FIG. 6 may be implemented in hardware, software, or a combination of the two, and computer-readable instructions that perform such steps may be stored in a memory, such as any of the memories of terminal 200 shown in FIG. 2. Not all of the steps shown in FIG. 6 may be required in all embodiments, as some steps may be omitted.

In step 601, a media signal (e.g., a broadcast or narrowcast signal, a satellite signal, a streaming program over the Internet or other network, or the like) is received at a terminal. The media signal may comprise a composite media signal comprising many different audiovisual programs that may be selected and demodulated for viewing.

In step 602, one of the audiovisual programs is selected (e.g., by a channel selection button on a remote control) and demodulated and/or decoded or otherwise processed. The signal may be, for example, in analog or digital form, and hence any of various types of demodulation, demultiplexing, decryption, and other processing may be performed to obtain the selected audiovisual program.

In step 603, the audio and video components of the audiovisual program may be split into separate streams. In one variation, the streams may comprise audio PES and video PES streams such as may be found in the MPEG-2 standard.

In step 604, a user interface is generated. In some variations, the user interface may include options for selecting an audio and video path, and for prompting the user to perform synchronization adjustments. As explained previously, some embodiments may include a simulated audiovisual program having one or more moving video objects that are rendered with a corresponding audio component that makes a striking sound (e.g., a ball bounce) corresponding to a point in time where the one or more video objects strike a surface or other object. In other embodiments, a live audiovisual program such as one currently being viewed by the user may be used.

In step 605, the user may select an audio and a video path to be synchronized. Examples of this step were described in connection with FIGS. 3B through 3D.

In step 606, in response to user input (e.g., via a remote control), one of the audio and video paths is variably delayed. This variable delay may be introduced using variable buffer delay logic 104 or by other means, such as a processor programmed to delay one stream relative to another or an application-specific integrated circuit. The current amount of delay may be optionally displayed to the viewer.

In step 607, a determination is made as to whether the user is still adjusting the delay. If not, processing resumes at step 606, and the audio or video path is variably delayed until the user is satisfied with the synchronization between audio and video paths.

In step 608, the delay settings may be saved in a memory and used to adjust the audio or video paths for future programming choices.

While illustrative systems and methods as described herein embodying various aspects of the present disclosure are shown, it will be understood by those skilled in the art, the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. For example, any of the above described systems and methods or parts thereof may be combined with the other methods and systems or parts thereof described above. For example, one of ordinary skill in the art will appreciate that the steps illustrated in the illustrative figures may be performed in other than the recited order, and that one or more steps illustrated may be optional in accordance with aspects of the disclosure. It will also be appreciated and understood that modifications may be made without departing from the true spirit and scope of the present disclosure. The description is thus to be regarded as illustrative instead of restrictive.

What is claimed is:

1. A method comprising:
receiving, at a terminal, a plurality of audiovisual programs, each audiovisual program having an audio component and a video component multiplexed together into the audiovisual program;
in the terminal, separating one of the audiovisual programs into an audio component and a video component;
in response to user input, variably delaying in the terminal one of the audio component and the video component in relation to the other component; and
outputting the audio component and the video component from the terminal.

2. The method of claim 1, further comprising:
generating a user interface comprising a video component and an audio component and including instructions for prompting a user to variably adjust synchronization between the audio component and the video component.

3. The method of claim 2, wherein the user interface comprises a simulated moving video object and an audio sound corresponding to the simulated moving video object striking another object.

4. The method of claim 2, wherein the user interface comprises a user-selected audiovisual program corresponding to one of the plurality of audiovisual programs.

5. The method of claim 2, wherein the audio component comprises a packetized elementary audio stream and the video component comprises a packetized elementary video stream.

6. The method of claim 2, wherein the user interface is configured to permit the user to select an audio path and a video path to be synchronized.

7. The method of claim 1, further comprising the step of storing in a memory of the terminal a delay value representing an amount of user-adjusted delay between the audio and video components to be applied for each audiovisual program.

8. The method of claim 7, further comprising the step of storing in the memory of the terminal a delay value for each of a plurality of audio and video signal paths in the terminal, such that separate delay values are stored for each audio/video path combination.

9. The method of claim 2, wherein the user interface generates a display indicating a current amount of user-specified delay between the audio component and the video component.

10. The method of claim 1, wherein the user input is received from a remote control device that communicates wirelessly with the terminal.

11. Apparatus comprising:
a processor; and
a memory storing instructions that, when executed, cause the apparatus to:
receive, at the apparatus, a plurality of audiovisual programs, each audiovisual program having an audio component and a video component multiplexed together into the audiovisual program;
in the apparatus, separate one of the audiovisual programs into an audio component and a video component;
in response to user input, variably delay one of the audio component and the video component in relation to the other component; and
output the audio component and the video component stream from the apparatus.

12. The apparatus of claim 11, wherein the instructions, when executed, cause the apparatus to:
generate a user interface comprising a video component and an audio component and including instructions for prompting a user to variably adjust synchronization between the audio component and the video component.

13. The apparatus of claim 12, wherein the user interface comprises a simulated moving video object and an audio sound corresponding to the simulated moving video object striking another object.

14. The apparatus of claim 12, wherein the user interface comprises a user-selected audiovisual program corresponding to one of the plurality of audiovisual programs.

15. The apparatus of claim 12, wherein the audio component comprises a packetized elementary audio stream and the video component comprises a packetized elementary video stream.

16. The apparatus of claim 12, wherein the user interface is configured to permit the user to select an audio path and a video path to be synchronized.

17. The apparatus of claim 11, wherein the instructions, when executed, cause the apparatus to store in a memory of the apparatus a delay value representing an amount of user-adjusted delay between the audio and video components to be applied for each audiovisual program.

18. The apparatus of claim 17, wherein the instructions, when executed, cause the apparatus to store in the memory of the apparatus a delay value for each of a plurality of audio and video signal paths in the terminal, such that separate delay values are stored for each audio/video path combination.

19. The apparatus of claim 12, wherein the user interface generates a display indicating a current amount of user-specified delay between the audio component and the video component.

20. The apparatus of claim 12, wherein the user input is received from a remote control device that communicates wirelessly with the apparatus.

21. A memory having stored therein instructions that, when executed by a processor, perform:
receiving, at a terminal, a plurality of audiovisual programs, each audiovisual program having an audio component and a video component multiplexed together into the audiovisual program;
in the terminal, separating one of the audiovisual programs into an audio component and a video component;
in response to user input, variably delaying in the terminal one of the audio component and the video component in relation to the other component; and
outputting the audio component and the video component stream from the terminal.
